(19) United States
(12) Patent Application Publication
(10) Pub. No.: US 2016/0371610 A1
(43) Pub. Date: Dec. 22, 2016

(54) EVENT PRE-TICKET ADMISSION SYSTEM

(71) Applicant: BLESSINGS BOUNTIFUL, LLC, Atlanta, GA (US)

(72) Inventor: JAMES S. BRONNER, Atlanta, GA (US)

(21) Appl. No.: 15/183,684

(22) Filed: Jun. 15, 2016

Related U.S. Application Data
(60) Provisional application No. 62/181,190, filed on Jun. 17, 2015.

(51) Int. Cl. G06Q 10/02; G06Q 20/40; G06F 17/30

(52) U.S. Cl. CPC G06Q 10/02; G06F 17/30864; G06Q 20/401

(57) ABSTRACT

A system and method for managing advance ticket sales for an event without engaging in a financial payment transaction online. The method comprises the sale of a pre-ticket which may be redeemed online, i.e. via the Internet, by a user to obtain an admission ticket to the event. A non-admissible pre-ticket with a unique alphanumeric code and scratch-off security layer is also provided. The system including the pre-ticket provides means for tracking sales logistics and reducing fraud and loss prevention in event ticket sales, for more efficient administration of event admission at the event, and additionally for projecting event attendance and planning event content.

### TECHNICAL FIELD

This application relates to inventions that are used in the field of ticketing and admission to predetermined private or public events such as entertainment shows, conferences, exhibitions and workshops.

### BACKGROUND

Shows and large group events often present logistics challenges for the event organizers, including collecting attendee registration information such as name and contact information. Handwritten registrations are often difficult to read, and the information may be lost before it can be collated into a database for ticket verification at the gate or to allow follow up communication with attendees after the event. When tickets are being distributed through multiple outlets such as salespersons and retail locations, they may be lost or otherwise be unaccounted for, and it is therefore difficult to ascertain whether the ticket price for an attendee in possession of the ticket has actually been remitted back to the event organizers. It is also difficult for organizers to allow for selective discounting of tickets, for example for early registration or to issue complimentary tickets (“comps”), while tracking the number of such special priced tickets before and after the show. There is an additional issue presented by counterfeit tickets, the proceeds of which are collected by persons other than the event organizer, and this can lead to loss of ticket revenues for the event.

Electronic transactions may allow a purchaser to log on to an Internet website and make a purchase via an electronic payment transaction. However, online payment for an event ticket purchase may not be an accessible option for customers who do not have credit card or electronic payment accounts to facilitate payment. Yet, such purchasers want the convenience of being able to register for events online or to avoid waiting in line at an event to purchase a ticket without being refused entry because the event was sold out earlier. In addition, purchasers and event organizers have concerns about the collection of credit card information because of the large breaches of data security that have become commonplace. Yet, without taking advantage of efficient electronic means, selling tickets and the slow processing caused by having to manage cash transactions at the gate can result in long lines and inefficient administration of the event. The event also becomes susceptible to financial losses from poor cash management.

There is therefore a need for a method of obtaining tickets to an event which does not require old-fashioned methods of selling tickets directly at the gate, but which allows purchasers to purchase before the event and register online, and also avoid using credit card information online. Additionally, there is a need for a system that includes a separate process that allows monies to be collected for ticket sales before an event and another process for providing tickets for actual admission to the event. There is a further need for providing means of tracking changes in ticket price, either according to early or late registration pricing or based upon discounts or comps, and accounting for such changes in pricing at the point of ticket redemption. There is further a need for a method of tracking sales of tickets for reconciliation purposes and to prevent revenue losses because of lost, missing or untraceable tickets. There is also a need for an improved means of tracking user information and demographics to provide input into scheduling of the event's activities and to facilitate the planning of future events.

### SUMMARY OF THE INVENTION

The invention comprises a system and method for managing admission to an event that allows advance purchase and online ticket issuance and registration but without an online purchase transaction. The system additionally provides improved tracking of ticket distribution and sales, reduces the likelihood of fraud in the ticketing and admission process and enables selective discounting of tickets during the sales process. The system also facilitates correlation of prospective attendance to the event schedule.

The pre-ticket of the invention is designed to save time for vendors by simply allowing them to sell a pre-ticket to a customer or prospective event attendee and yet not have to collect any information directly from the buyer. The buyer, in turn, does not have to make a ticket purchase online from the event organizer, but can instead retrieve an event ticket online using a pre-purchased pre-ticket. The pre-ticket is not a ticket and cannot be used to gain admission to the event. Rather, the pre-ticket directs the buyer to scratch off a ticket reservation code and then use that code to register online. Upon completion of registration online, the buyer may download and print a ticket on paper or choose to receive an electronic ticket (“e-ticket”), either of which can be presented for event admission. The invention thus allows ticket monies to be collected before an event and not at the gate, and for this collection to be done without collecting purchasers' payment information such as credit cards using online collection means.

The invention further comprises a method of collecting purchaser registration information, such as name, address and other contact information by electronic means via use of the Internet before an event, without the need for completing a financial transaction or sharing sensitive payment information online. Also provided is a means of managing event admission sales by adjusting the price of the pre-ticket, and for tracking and accounting for such changes in the pre-ticket price. The invention also provides a method for tracking and accounting of pre-ticket sales for reconciliation purposes, and of tracking and disabling lost or stolen pre-tickets. Such tracking may for example comprise a computerized audit that is activated on demand to process and report pre-tickets sold, completed registrations, prices and ticket revenues.

Further provided is a means of collecting and tracking the demographic profiles of attendees who register with pre-tickets and using this information to develop or modify the schedule of event activities to match the interests of those attendees.

In one aspect, the invention relates to a discrete, verifiable pre-ticket comprising a unique alphanumeric ticket reservation code printed thereon. This ticket reservation code is obscured by a security scratch off layer. Each ticket reservation code is included in a data set that is loaded into a computer database before the tickets are printed. The sale price of the pre-ticket is matched to a predetermined price and the ticket reservation code in a database stored on a server computer. In this respect, the tickets may be isolated into blocks for distribution based on the event organizer's desire to give particular discounts or special pricing, e.g. for student attendees or comp tickets to corporate sponsors.

In general application, a user who possesses a pre-ticket bought at a predetermined price is directed to log in, via a computer, to a webpage identified by a uniform resource locator (URL). The customer enters the ticket reservation code. The computer matches the entered ticket reservation code to the data record corresponding to that code and generates a sequence of coded steps that grants the customer access to a registration page. The customer is prompted to enter registration information such as name, address and other demographic or survey data that the computer software then associates with the ticket reservation code. Upon completion of the registration information, the customer is directed to a review page, then to a print page on which is displayed a printable electronic replica of a ticket. The customer is prompted to print or download the ticket. The customer then takes the ticket to the event and presents it for admission.

Implementing this pre-ticket system allows the buyer two advantages when compared to directly buying a ticket online. First, the pre-ticket locks in the price offered by the sales person or retail agent at the time the offer of sale is made. This benefits the customer as ticket prices may continue to increase as the start date of the event approaches. In addition, the system allows a buyer to pay with means including but not limited to cash for advance registration to the event instead of having to pay online. Removing the need for online payment, plus registration for the same transaction, reduces the risk of the purchaser being exposed to security breaches in which the security of consumer personal information is compromised. It also alleviates the need for the event organizer to invest in costly electronic security measures to protect credit card information particulars which, despite best efforts, could still be subject to compromise. In addition, the ticket reservation code associated with the scratch off security feature allows the event organizer to deactivate any lost or stolen tickets. The unique scratch off ticket reservation code also prevents any counterfeiting activities since each such code can only be used in registration once.

These and other objects, features and advantages of the present invention will be apparent from the following illustrative figures and description of embodiments.

### BRIEF DESCRIPTION OF DRAWINGS

FIG. 1 is a plan representation of the front of a pre-ticket according to the invention showing ticket security feature in the form of a scratch-off panel and a bar code.

FIG. 2 is a plan view of the back of a pre-ticket according to the invention.

FIG. 3 is a plan view of the front of a pre-ticket showing a unique alphanumeric ticket reservation code beneath a scratch-off panel.

FIG. 4 is a flow chart showing the computer elements associated with the invention.

FIG. 5 is a schematic diagram of a process of event ticket administration according to the invention.

FIG. 6 is a schematic of the computer-based steps for pre-ticket processing for an event according to the invention.

### DESCRIPTION OF PREFERRED EMBODIMENTS

The system and printed media of the invention are used for ticket sales and management of large events such as trade shows, conferences, workshops and entertainment events where the attendance ranges from hundreds to thousands. However, it can also be implemented for smaller events. Such events often involve ticket sales or distribution of complimentary passes. Tickets may also be sold at different prices, for example to charitable organizations or to selected groups of customers. As used herein the term “ticket” encompasses single entrance or multi-entry event tickets as well as exhibitor passes and gate passes for speakers, presenters and event staff. An event may be an entertainment show, a conference, a learning event, workshop, trade show, or other events offered to ticketholders or subscribers who attend such events in person.

In an aspect the invention comprises a system with improved payment transaction security for event ticket sales and distribution for an event requiring ticketed admission. This system comprises: a pre-ticket sold to a user which has printed thereon a unique alphanumeric ticket reservation code and further comprises a security scratch-off layer superimposed over the ticket reservation code that obscures it from view; a computer associated with one or more databases which include the unique alphanumeric ticket reservation codes for the event and predetermined ticket prices stored therein; a user-initiated online ticket redemption process which includes a verification process initiated by the user which identifies the pre-ticket as a verified pre-ticket; and an online registration process that is activated upon completion of the verification process, and which provides issuance of a pre-paid event admission ticket when it is presented at the entrance to the event.

The invention further comprises printed pre-tickets for secure distribution of tickets to an event which are issued to a purchaser or person interested to attend the event. In this respect the pre-ticket comprises a printed medium having printed on at least one side thereof identifying particulars relating to the event, a unique alphanumeric ticket reservation code and a security scratch-off layer superimposed over said ticket reservation code; wherein the ticket reservation code is associated with one or more fields of data in at least one remote computer database. These fields of data relate to various ticket categories, ticket prices and discount values. The pre-ticket cannot be purchased online, nor can it be used for admission to the event; rather it must be purchased separately and then verified remotely by accessing a computer system server. A particular object of the invention is to separate the payment transaction relating to purchase of the pre-ticket from the sequence of online transactions conventionally associated with an online ticket purchase in order to reduce the likelihood of breaches of electronic security. The pre-ticket is used in combination with, but in a segregated step from the processes of providing a purchased admission ticket and registering the holder of the ticket as an attendee at the event. Only after verification is a ticket issued to the purchaser, which can be presented for admission to the actual event. The pre-ticket of the invention may be printed on various media, including but not limited to paper stock, plastic, and plastic wallet-sized cards. Any conventionally known printable media may be used.

The invention additionally comprises a method for pre-registering an attendee to an event without causing the attendee to engage in an online financial transaction for purchase of admission ticket to the event. This method comprises creating at least one computer database having included therein one or more series of unique ticket reservation codes and a range of ticket prices for admission to the event which reflects full or discounted prices, wherein each ticket reservation code is uniquely matched with a predetermined ticket price in the database and a discount value; selling a pre-ticket to a customer that is printed with a unique alphanumeric ticket reservation code that corresponds to the actual ticket sale price, and providing instructions for a user of the pre-ticket to access an online Internet registration site via a computer for redemption of the pre-ticket for an admission ticket. The method generally comprises verifying the authenticity of the pre-ticket, upon entry of the unique alphanumeric ticket reservation code by the user into a computer, wherein the step of verifying authenticity comprises matching the alphanumeric ticket reservation code to the corresponding predetermined ticket price in the computer database, and further includes applying the discount value associated with the predetermined ticket price; transmission of verifying information from the system computer back to the user interface; collecting identifying attendee information via the Internet registration site; issuing an admission ticket to the event for printing to the computer being used to access the Internet registration site; and tracking use of the pre-tickets using the information obtained from the steps of verifying the authenticity of the pre-ticket and collecting identifying attendee information via the Internet registration site.

The system and methods of the invention require the implementation of a pre-ticket equipped with a removable security coating layer that conceals an identifier unique to singular tickets. Scratch coatings and methods to apply them have evolved over time in an effort to improve security. The coating may include one or more materials, for example a polymeric or metallic material such as metal foil or acrylic. The scratch-off layer may be printed over the ticket reservation code by conventional means, for example as an ink layer deposited by an inkjet printer or an acrylate, latex or other polymer coating. Conventional methods and materials for creating a scratch-off security layer are available from multiple suppliers.

The coating may be applied in one layer or multiple layers which can for example include a concealing layer, overprint layer and one or more confusion layers that obfuscate any printed information beneath the coating. Alternatively, the coating may consist of a single layer that provides sufficient security coverage. The coating may be applied at thicknesses determined by a computer-controlled deposit process.

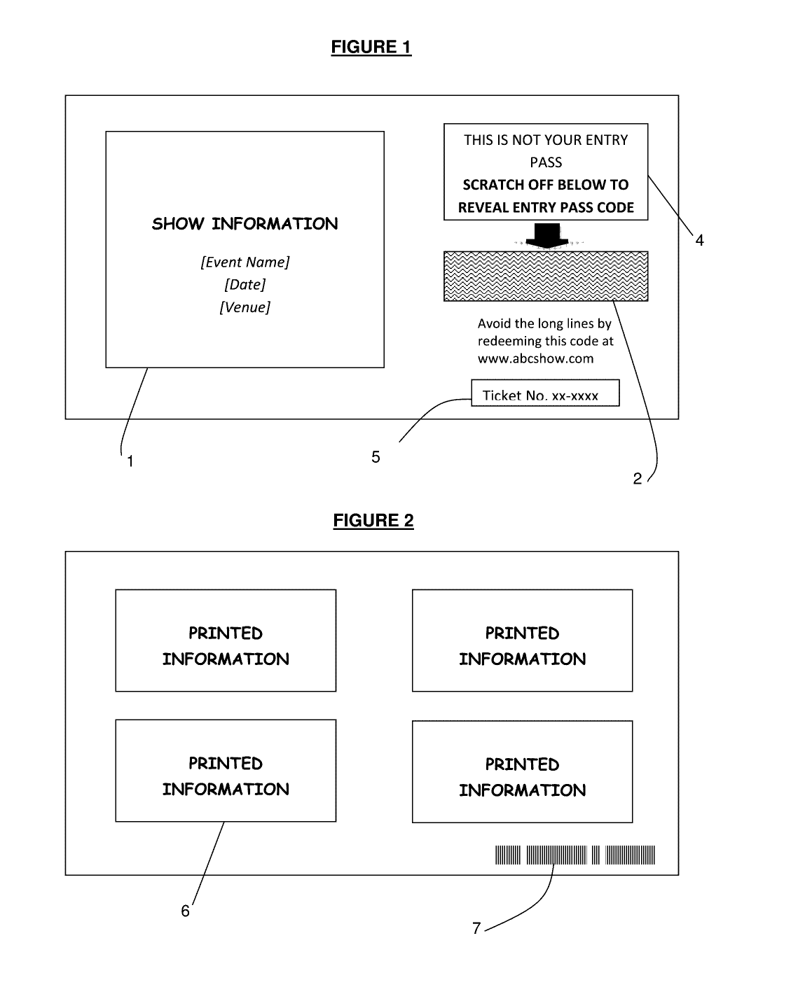

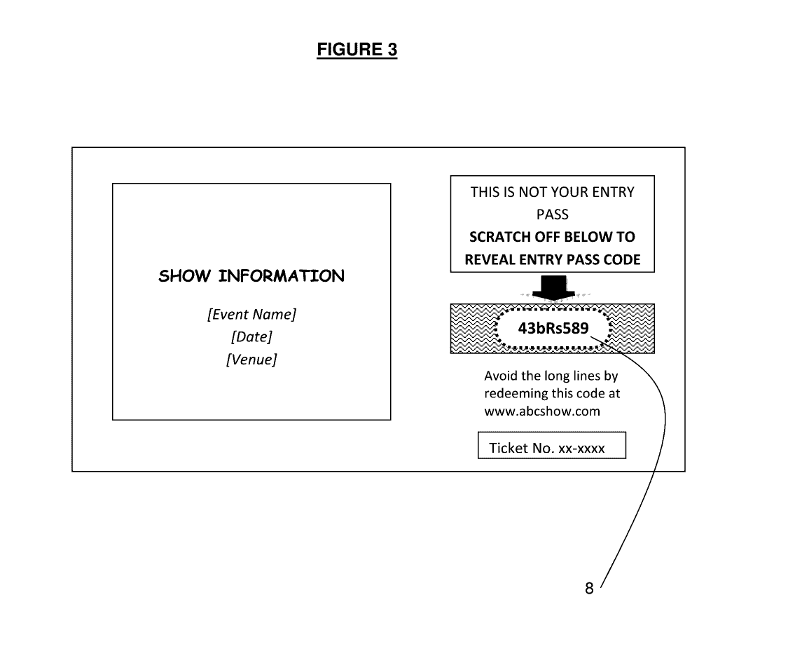

According to the example embodied in FIG. 1, the front of a pre-ticket of the invention 100 is printed with event information 1 such as the show title, date and venue. A scratch-off panel 2 is obviously visible and is associated with written instructions 4 for using the pre-ticket. As shown, an individual pre-ticket number 5 may also be included as a means for supplemental verification of the pre-ticket during the registration process. The back of the ticket may be blank, or the space on the reverse side may include additional printed information 6 regarding the show, sponsor advertisements, terms and conditions of show attendance or any other information desirably to be communicated to the buyer of the pre-ticket. The back of the pre-ticket as shown in FIG. 2 includes a barcode 7, which may be included, as desired, as a further pre-ticket identifier for security verification purposes. It should be understood that such security means may be implemented anywhere on either surface of the pre-ticket. Bar coding may be accomplished using a conventional UPC barcode or by QSR codes or other known coding means. The scratch-off coating layer on each pre-ticket conceals a reservation code that is a unique alphanumeric code sequence. The ticket reservation code is selected from a series of such codes predetermined, selected and matched to the pre-ticket to be printed. The codes are generated by a computer using an algorithm which provides a scrambling of letters, numbers and/or symbols to create series of unique codes that cannot readily be duplicated or generated manually according to a mental sequence. The codes are stored in a computer database. These codes may be assigned, in series or in blocks that correspond to blocks of tickets, and physically imprinted upon the pre-tickets during the printed process. The series of unique alphanumeric ticket reservation codes is also entered into a database that is accessible by a computer. In this manner, a user of a pre-ticket who uses the unique alphanumeric ticket code to obtain an admission ticket to the event will enter the ticket reservation code into a computer to be matched to the identical code in the database as part of the verification process, which is further discussed below. Typically, removal of the scratch-off security layer 2 is required to expose a unique alphanumeric ticket reservation code 8. The ticket reservation code 8 (FIG. 3) may be a unique combination of letters, numbers and symbols which is used only once, one per pre-ticket.

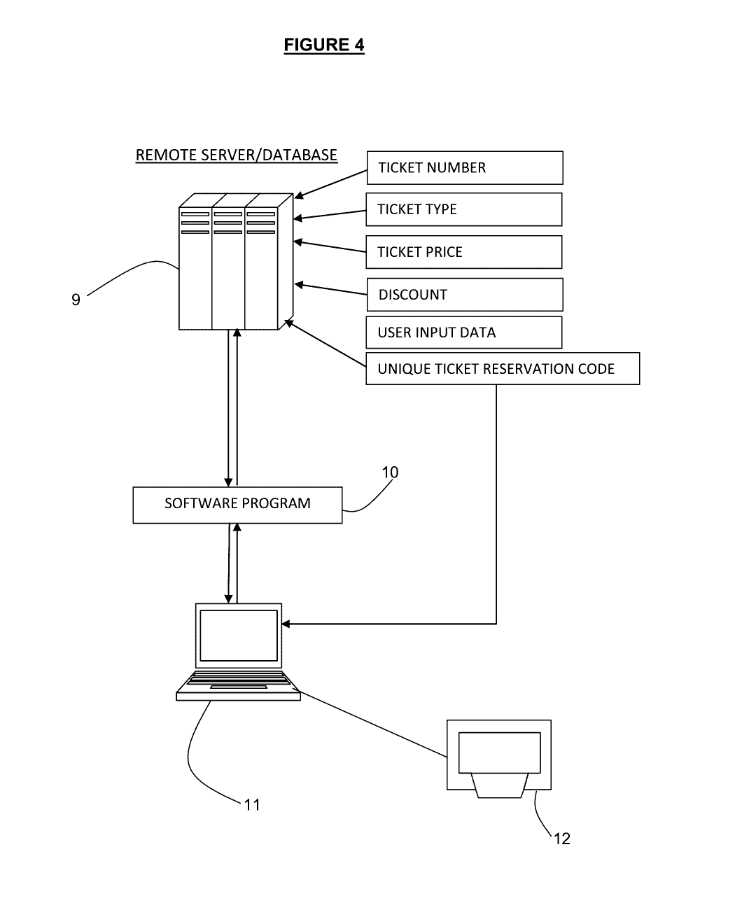

In addition to being uniquely associated with a single pre-ticket, each ticket reservation code is also correlated to a ticket type and ticket price and other data qualifiers. In this respect, an event may have different types or levels of admission, for example the type of ticket may vary by the location of seats or the scope of program attendance permitted by the admission, for example one day of a multi-day event. These tickets may attract different prices, and therefore the range of relevant prices is also entered into the database and associated with the individual pre-tickets. A computer system (FIG. 4) according to the invention comprises a remote server 9, with which is associated one or more databases that house information relevant to discrete ticket purchases and ticket registrations. The remote computer server database may include different types of tickets, depending on the categories of persons or groups identified as potential attendees at the event. The computer system may be a remotely located computer which is controlled by the event owner or by a contracted third party, such as an event logistics vendor. The information stored by the server includes but is not limited fields such as pre-ticket numbers or ticket numbers, a preset batch or batches of ticket reservation codes, predetermined ticket prices to which certain ticket numbers may be assigned, as well as one or more predetermined ticket discount codes stored in one or more databases. User input information is also stored. The database is administered by a software program that may be associated directly with the server or be connected remotely. The software program 10 receives user input regarding the ticket reservation code to access data from the remote server and to facilitate computations of ticket prices and discounts. The software program 10 is also coded to facilitate further data collection from the user after the ticket reservation code is entered. The computer system is associated, via the software program, with the user's computer access interface 11. At the user interface a user logs into a website using a URL provided on the pre-ticket. The user is then able to input the ticket reservation code and other information, and to receive an electronic copy of an admission ticket to the event as well as other information. The system may also include a printer 12. It should be noted that the printer may be excluded as the admission ticket can be received electronically by the pre-ticket user then stored and presented in electronic form for admission to the event. As described above, it should be apparent that the steps performed by one or more computers in the methods of the invention involve transformations of data that cannot be accomplished manually, and thus the computer operations are necessary to the practice of the online components of the claimed invention.

Additionally, in a preferred embodiment, a ticket reservation code is associated with a price and with a predetermined discount equivalent to 100%, which effectively reduces the ticket price to zero at the user interface. In this respect, the pre-ticket is associated in the computer database with a ticket for which no payment is due, i.e. it is effectively recognized as “free.” The issuance of an admission ticket thus requires no online payment by the purchaser during the process of ticket issuance and before it is delivered. In other embodiments, a less than 100% discount may be applied, for example if the ticket reservation code is additionally associated with a loyalty discount code or other coupon in addition to the pre-ticket purchase price that was previously entered into the database. In this case more than one discount can be applied. However, in no circumstance would the user of the pre-ticket be required to make any additional payment during the online process of redeeming a pre-ticket. The ticket reservation code may also be matched to other identifiers for verification purposes.

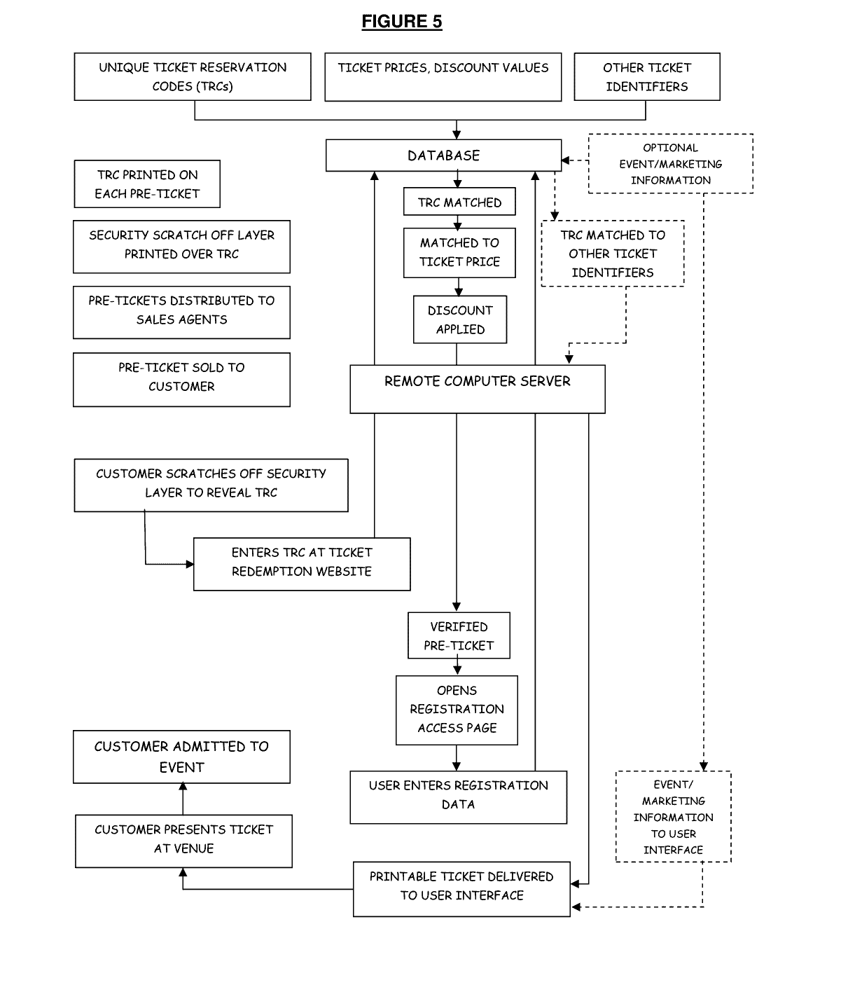

According to FIG. 5, batches of pre-tickets with printed and concealed unique ticket reservation codes are distributed to vendors including sales agents, merchant retailers and other distributors. A log of distributed ticket numbers may be kept, and the identity of the vendors may also be entered into the database associated with the pre-ticket numbers and the ticket reservation codes. Ticket prices and discount values to be applied are also in the database. In this manner, database reports can be generated as to the sales per vendor and the disposition of the pre-tickets. The database may also include optional marketing or event information, such as sponsor information, speaker biographies and promotions for products or for other events. The pre-ticket is sold to customers for their own use or for use by prospective attendees at the event. A user then follows the instructions printed on the pre-ticket and scratches off the security coating layer to expose the unique ticket reservation code. The process of redeeming a pre-ticket for an event admission ticket involves a verification process which is typically associated with a registration process. The ticket redemption steps are completed online, the sequence beginning at the point of verification of the previously purchased pre-ticket. In an embodiment, the verification process comprises transmission of the ticket reservation code entered by the user to the computer; matching of the information received by the computer to predetermined records among the data stored by the computer to verify the authenticity of the pre-ticket and generate a verified pre-ticket; association of selected, pre-determined information with the verified pre-ticket; and transmission by the computer of information back to the user interface. From a computer, which may be a personal computer (PC), smartphone, mobile computer or other computer, the buyer logs on to a ticket redemption website and enters the ticket reservation code into the user interface of a computer software program. The information pertaining to the ticket reservation code is transmitted to a remote computer server in communication with the one or more databases of information. Software execution steps match the ticket reservation code to the ticket price and a discount, as well as to any other required identifiers programmed into the system to complete the verification. When the price, discount and ticket reservation code are all matched in the database, the remote computer transmits verification, i.e. the existence of a verified pre-ticket, back to the user's computer. The user is then directed to a registration access page. The user is prompted to register the attendee and optionally to provide requested demographic information as discussed herein. The user may be asked to provide and may elect to respond with information regarding event preferences, e.g. signup for specific sessions. The information submitted by the user is transmitted back to the remote computer or server. Once the registration process is complete, the user may access a ticket retrieval page where the user can securely download an admission ticket for entry to the event. The server also retrieves and sends event or marketing information from the database to the user.

The computer software program is, in certain embodiments, a ‘plug-and-play’ electronic ticketing or box office management system which may be associated with the database that stores the ticket reservation code, ticket prices and other information. The program may be housed on a remote computer or be cloud-based. The program is configured to receive information from the pre-tickets and demographic data input by the user, and to recognize and process discounts to the preset ticket price. The unique alphanumeric ticket reservation code acts as a coupon code that is recognized as a 100% discount that is applied to the predetermined ticket price in the computer database. Entry of the pre-ticket ticket reservation code therefore prompts the program to verify the pre-ticket and record the electronic ticket to be redeemed from the pre-ticket as being fully paid. Specifically, the pre-ticket provides a URL for access to a website for ticket retrieval. Upon the user's entering the ticket reservation code at the website, the software program matches the ticket reservation code to the predetermined, pre-entered data set of codes, each of which is paired with a matching ticket type to provide verification of the pre-ticket. The verified pre-ticket is then matched with a discount that equals 100% of the predetermined ticket price. The computer program then issues a discount credit that is equal to the particular purchase price paid by the buyer. In this respect, the ticket price is recognized by the software program as fully paid. The 100% discount is coded to apply to various ticket prices, therefore the event organizers may distribute pre-tickets to be sold at different prices. Further, the discount is applied at 100% even though admission prices may later be varied, for example because of changes in admission price, and as a result the corresponding pre-ticket price, closer to the date of the event, or because admission has been discounted for special purposes, e.g. school discounts. In this manner, even though pre-tickets may be sold at different prices, all will be eligible for conversion to an admission ticket via the ticketing software program without a change in the pricing initially offered. The one hundred percent discount may be derived through an equivalent discounting of the pre-ticket purchase price paid by the user. Alternatively, the user may pay a lesser purchase price and the software programmed to apply pre-programmed discounts such as student discounts, senior discounts or special pricing discounts. The discounts plus the prepaid ticket price then aggregate to 100%, allowing the software to satisfy the price matching algorithm and release the admission ticket.

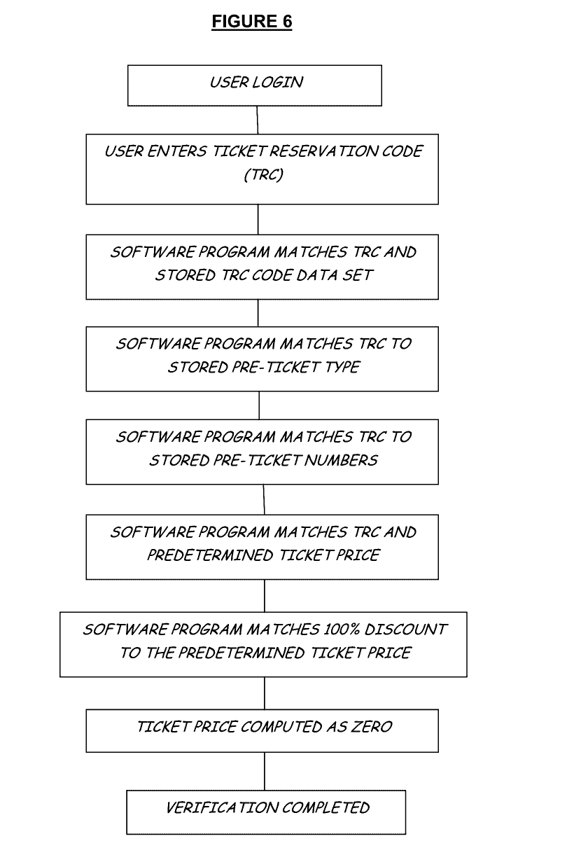

In a verification process per the embodiment of FIG. 6, the user logs in via a personal computer (PC) or via a mobile computing device such as a smartphone or tablet. The software program, which is in communication with the remote server and its associated databases matches the ticket reservation code to the batch of stored ticket reservation codes that were pre-entered in the database before the pre-tickets were distributed to vendors. Additional matches with other database fields are performed simultaneously or in sequence. These steps include matching the ticket reservation code to the ticket type, ticket price and to the ticket discount. To enable the user to claim a ticket without making an online transaction, the unique ticket reservation code is matched to a 100% discount, which when applied causes the ticket price payable by the buyer of the pre-ticket to be computed as zero, effectively designating the ticket to be released as a “free” ticket. The user is notified that the ticket is available for download once the verification process is complete.

Once the verified pre-ticket has been generated, the user is prompted at the user interface to enter certain registration and additional demographic information to be associated with the issued ticket in the database. Preferably, the user interface of the ticket redemption website provides access to a registration page with template fields into which the buyer is prompted to enter information that is transmitted to and recorded by the software program in the database. Some or all of these information fields may be preset as mandatory and optional fields, depending on the type of demographic information desired to be collected. Typically, mandatory fields will include the user's name and contact information such as physical address, email address and telephone number. Optional fields may include the email addresses and a request to permit future correspondence by the event organizer or its affiliates. Other optional fields may include a business name, professional occupation, interest in particular event topics and in interest in receiving follow up information. Any of these optional fields can alternatively be designated as mandatory fields. In addition to this basic information, the user may be invited to provide other information such as selecting breakout sessions for the event, providing answers to polls, identifying topics of interest for future events, or subscribing to various mailing lists. The system can also transmit additional information from the server or remote computer back to the user's computer. Examples of information presented to the user may include confirmation messages, coupons, advertisements, general information about the event organizer or participants, hosts, presenters, etc., or event details.

Upon receiving the basic identifying information for the event attendee, the software program prompts the user directly to receive and download a printable, paid admission ticket for entry to the event. In this regard the software operations direct the opening of a further web page with the ticket. The ticket may also include a machine readable code, e.g. a bar code or a quick response (QR) code. The ticket may also be saved as an image by a smartphone and presented as an electronic image at the point of admission. The electronic ticket may be printed from the computer via an associated printer, or it may be emailed to the user or sent as a text to a mobile phone. Alternatively, a computer terminal may be set up at the event to allow pre-ticket holders to log on to the website and process the e-ticket right before entry into the event. Reader devices may also be used at the event entrance to scan bar codes, QR codes or other forms of electronic tickets.

The pre-ticket system of the invention solves certain problems specific to the event management industry. In one aspect is provided a system for managing ticket sales logistics and distribution for an event requiring ticketed admission to prevent revenue loss because of tickets that are not accounted for. The information derived from the verification step is used to generate reports that, for example, track usage of paid tickets as registrations, numbers of tickets sold, gross revenues, demographic information regarding attendees at the event, the total monetary value of discounts applied, identification of lost, spoiled or unused tickets and fraud prevention. Lost or stolen tickets can be deactivated, for example by removing the ticket reservation code from the database or by associating the code with a deactivation response identifier which flags the ticket as invalid, so they cannot be used to claim admission tickets to the event. Therefore, the efficiency of the computer-based management of event admissions is improved. The speed of computer-based ticket generation is also increased because there is no intervening payment transaction.

The event admission information obtained from the online registration may be used to track various metrics relating to the event. For example, the number of pre-tickets redeemed for admission tickets can be tracked as well as the number of unredeemed pre-tickets that were sold or not distributed. The demographic information obtained from the pre-ticket registration process enables the event organizer to make adjustments to the event schedule before the start of the event. Such use of the attendee information may, for example, be desirable in a multi-day event to ensure that the content presented during the event sessions is targeted to the audience that will actually be in attendance on a particular day. The demographic information also enables the event organizer to plan for future events based on the history of attendance at previous events. Additionally, event breakout sessions or workshops may be added or deleted, all in advance, based on the data obtained from the user's indicated preferences during ticket registration.

This invention and the various embodiments and characterizations thereof are useful in the field of event management, specifically in the area of ticketing, ticket sales management and revenue control, loss prevention and event planning using attendee demographic data. Events that may be managed using the system and the pre-ticket of the invention include professional trade shows, conferences, conventions and entertainment events.

It is to be understood that the foregoing described invention is not limited to the precise embodiments thereof which are described herein. Various modifications, including equivalents recognized in the art for the various components, can be employed by one skilled in the art as being within the scope and spirit of the invention, as it is characterized by the claims herein.

1. A system with improved payment transaction security for event admission ticket sales and distribution for an event requiring ticketed admission, which comprises:
a) a pre-ticket sold to a user which has printed thereon a unique ticket reservation code and further comprising a security scratch-off layer superimposed over the ticket reservation code that obscures the printed code;
b) a computer associated with one or more databases having information including ticket reservation codes and predetermined ticket prices stored therein;
c) a user-initiated online ticket redemption process which includes
a verification process initiated by the user, in which a computer software program matches the ticket reservation code to the information stored in the one or more databases and identifies the pre-ticket as a verified pre-ticket, and
a registration process that is activated upon completion of the verification process;
and which excludes an online payment step and provides issuance of a pre-paid event admission ticket based upon the pre-ticket; and
d) admission of the holder of the pre-paid event admission ticket to the event when it is presented at the entrance to the event.

2. The system of claim 1 wherein the registration process collects and provides information regarding pre-ticket usage and demographic information regarding the user to the event organizer.

3. The system of claim 2 wherein the user-initiated online ticket redemption process provides one of more of reports that track usage of paid admission tickets, demographic information regarding overall attendance at the event, or identification or lost or unused pre-tickets to the event organizer.

4. The system of claim 1 wherein the registration process comprises:
entering the unique ticket reservation code into one or more fields at a user interface provided by an Internet website which accesses the databases;
subjecting the pre-ticket to the verification process; and
generation of information that characterizes an event admission ticket at the user interface.

5. The system of claim 4 additionally comprising entering the user's name or other demographic information at the user interface.

6. The system of claim 1 wherein the verification process comprises:
transmission of the ticket reservation code entered by the user to the computer;
matching of the information received by the computer to predetermined information in the one or more databases stored by the computer to verify the authenticity of the pre-ticket and generate a verified pre-ticket;
association of selected, pre-determined information with the verified pre-ticket; and
transmission by the computer of verifying information back to the user interface.

7. The system of claim 6 wherein in the process of generating a verified pre-ticket, a computer
identifies the correct price to be associated with the pre-ticket in the one or more databases,
identifies the monetary value of one or more discounts to be associated with the pre-ticket in the one or more databases,
applies the value of said one or more discounts to the price of the pre-ticket, and adjusts the price of the pre-ticket to zero.

8. The system of claim 6 wherein the verifying information transmitted back to the user interface by the computer defines a ticket for admission to the event.

9. The system of claim 8 wherein additional information is transmitted from the computer back to the user which is selected from confirmation messages, coupons, advertisements, general information or event details.

10. A pre-ticket for secure distribution of tickets to an event for use in the system of claim 1 comprising a printed medium having printed on at least one side thereof identifying particulars relating to the event, a unique alphanumeric ticket reservation code and a security scratch-off layer superimposed over said ticket reservation code; wherein the ticket reservation code is associated with one or more fields of data in a remote computer database which relates to various ticket prices and a discount value.

11. The pre-ticket of claim 9 further including information targeted to a user which is based on demographic information input by the user into a computer that is linked to the remote computer database.

12. A method for pre-registering an attendee to an event without causing the attendee to engage in an online financial transaction for purchase of admission ticket to the event, comprising:
a) creating one or more computer databases having included therein one or more series of unique ticket reservation codes and a range of ticket prices for admission to the event which reflects full or discounted prices, wherein each ticket reservation code is uniquely matched with a predetermined ticket price in the database and a discount value;
b) selling a pre-ticket to a customer that is printed with a unique alphanumeric ticket reservation code that corresponds to the actual ticket sale price, and providing instructions for a user of the pre-ticket to access an online Internet registration site via a computer for redemption of the pre-ticket with an admission ticket;
c) verifying the authenticity of the pre-ticket, upon entry of the unique alphanumeric ticket reservation code by the user into a computer, wherein the step of verifying authenticity comprises matching the alphanumeric ticket reservation code to the corresponding predetermined ticket price in the one or more computer databases; and further includes applying one or more discount values, said one or more discount values totaling a one hundred percent (100%) discount, to the predetermined ticket price;
d) collecting identifying attendee information via the Internet registration site;
e) issuing an admission ticket to the event for printing to the computer being used to access the Internet registration site; and
f) tracking use of the pre-tickets using the information obtained from the steps of verifying the authenticity of the pre-ticket and collecting identifying attendee information via the Internet registration site.

13. The method of claim 13 wherein a series of ticket reservation codes is matched with a selected ticket price to create blocks of pre-tickets for sale corresponding to the denomination of the selected ticket price.

14. The method of claim 13 wherein the step of issuing an admission ticket further comprises displaying marketing information regarding goods and services compatible with the event on the Internet registration site via the computer being accessed by the end user.

15. The method of claim 16 wherein the marketing information is printed on one or more surfaces of the admission ticket.

16. The method of claim 12 wherein the pre-ticket comprises a printed medium having printed on at least one side thereof identifying particulars relating to the event, a unique alphanumeric ticket reservation code and a security scratch-off layer superimposed over said ticket reservation.

17. The method of claim 16 wherein the pre-ticket further includes non-ticket related information printed on one or more surfaces thereof.
